(19) United States
(12) Patent Application Publication
(10) Pub. No.: US 2007/0180720 A1
(43) Pub. Date: Aug. 9, 2007

(54) Cross Level

(76) Inventor: Carmelo Gorgone, Brooklyn, NY (US)

Correspondence Address: LAW OFFICES OF ALOZIE N. ETUFUGH, PLLC, 30 CENTRAL PARK SOUTH, SUITE 4D, NEW YORK, NY, 10019, US

(21) Appl. No.: 10/905,015

(22) Filed: Dec. 9, 2004

(51) Int. Cl. G01C 9/24

(52) U.S. Cl. 33/382

(57) ABSTRACT

A cross level comprising a base having a first arm, a second arm, a third arm and a fourth arm; said first arm, said second arm, said third arm and said fourth arm extend along a common plane; said first arm is perpendicular to said second arm and said fourth arm; said third arm is perpendicular to said second arm and said fourth arm; said third arm extends 180 degrees from said first arm; and, said base comprising a plurality of level indicating means. The cross level may also have a means of emitting a laser beam. The present invention relates to a cross level that allows craftsmen to simultaneously level and/or plumb surfaces that are composed of discrete parts.

### BACKGROUND OF THE INVENTION

1. Field of the Invention

The present invention relates generally to a cross level used by craftsmen, such as artists, builders, cabinet makers, carpenters, contractors, draftsmen, engineers, machinists, masons, roofers, woodworkers and others for making various types of measurements, to determine whether a given structural member is level, plumb, and square, and measuring tool. More particularly, the present invention relates to a cross level that allows craftsmen to simultaneously level and/or plumb surfaces that are composed of discrete parts.

2. Description of the Related Art

Most craftsmen's levels have at least one reference edge and one or more bubble vials for correctly aligning the reference edge along a true horizontal or vertical plane. The prior art includes U.S. Pat. No. 6,807,743, issued to Odachowski, relates to a square level; U.S. Pat. No. 6,467,179, issued to Wolf, relates to a measuring and drafting tool; both of which are hereby incorporated by reference.

However, the prior art does not teach a cross level that allows a craftsman to level and/or plumb more than two surfaces on the same or different plane in more than two different directions from a common nexus. Usually this is a two-step process and/or a process involving more than one tool. The present invention cures these deficiencies, thereby saving time, labor and cost and increasing efficiency.

### BRIEF SUMMARY OF THE INVENTION

object of the present invention is a cross level comprising a base having a first arm, a second arm, a third arm and a fourth arm; said first arm, said second arm, said third arm and said fourth arm extend along a common plane; said first arm is perpendicular to said second arm and said fourth arm; said third arm is perpendicular to said second arm and said fourth arm; said third arm extends 180 degrees from said first arm; and, said base comprising a plurality of level indicating means. The cross level may also have a means for emitting a laser beam.

Further advantages and features of the invention will become apparent from the following description and the claims.

### BRIEF DESCRIPTION OF THE SEVERAL VIEWS OF THE DRAWING

FIG. 1 is a perspective view of one of the embodiments according to the present invention.

FIG. 2 illustrates an embodiment of the present invention being used in laying and aligning decorative tiles.

FIG. 3 illustrates an embodiment of the present invention being used in laying four tiles simultaneously.

FIG. 4 illustrates an embodiment of the present invention being used in laying twelve tiles simultaneously.

FIG. 5 illustrates an embodiment of the present invention being used in laying four tiles simultaneously.

FIG. 6 illustrates an embodiment of the present invention being used in laying five tiles simultaneously.

### DETAILED DESCRIPTION OF THE INVENTION

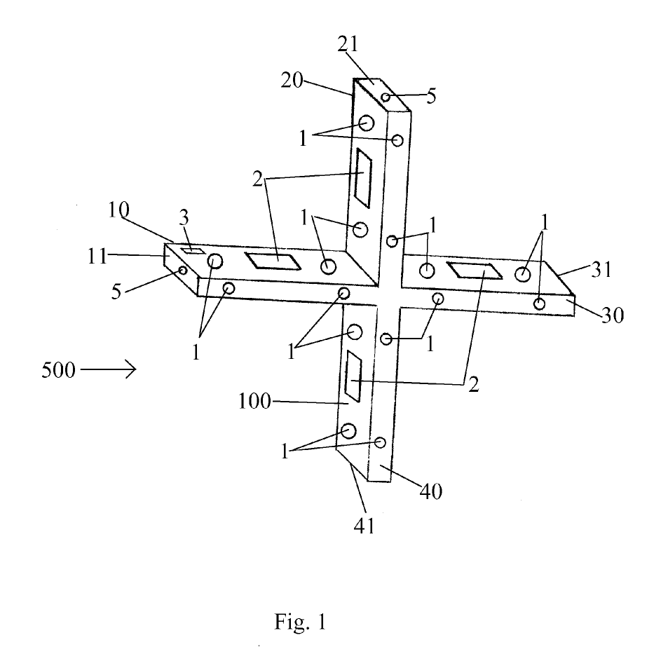

The cross level 500, as shown in FIG. 1, includes a base 100, having a first arm 10, a second arm 20, a third arm 30, and a fourth arm 40. The first arm 10, second arm 20, third arm 30 and fourth arm 40 extend along a common plane. The first arm 10 is perpendicular to the second arm 20 and to the fourth arm 40. The third arm 30 is perpendicular to the second arm 20 and to the fourth arm 40. The third arm 30 extends 180 degrees from the first arm 10. The overall length of the each of the first arm 10, second arm 20, third arm 30 and fourth arm 40 can be as desired.

The base 100 comprises a plurality of level indicating means 1. Each of the first arm 10, second arm 20, third arm 30 and fourth arm 40 includes at least one of the plurality of level indicating means 1 and at least one of the plurality of apertures 2. Each of the first arm 10, second arm 20, third arm 30 and fourth arm 40 includes a means for emitting a laser beam 5.

The first arm 10 also includes a temperature indicating means 3.

The level indicating means 1 may be arranged for indicating level (true horizontal) and plumb (true vertical), respectively, of any work surface against which any one of the base 100, the first arm 10, second arm 20, third arm 30 and fourth arm 40 are pressed. The level indicating means 1 are preferably carpenter's bubbles but other devices may be used alternatively.

The plurality of apertures 2 may aid the craftsman in storing, using or transporting the cross level 500. Each of the plurality of apertures 2 may be a hole, slit or opening.

The temperature indicating means 3 are preferably fluid thermometers, but other thermometers, such as a digital thermometer, may be used alternatively. The temperature indicating means 3 may be in Fahrenheit or Celsius. The temperature indicating means which allows craftsmen to determine the ambient air temperature, as bricklaying and tile laying should only be done when the ambient air temperature is at least about 35 degrees Fahrenheit or 3 degrees Celsius.

The cross level 500 may be constructed of metal, plastic, wood, other suitable materials, or combinations thereof.

The cross level 500 may contain a plurality of English system (e.g., inches, feet, etc) and/ or International System of Units (e.g., millimeters, centimeters, etc.) indicia marks.

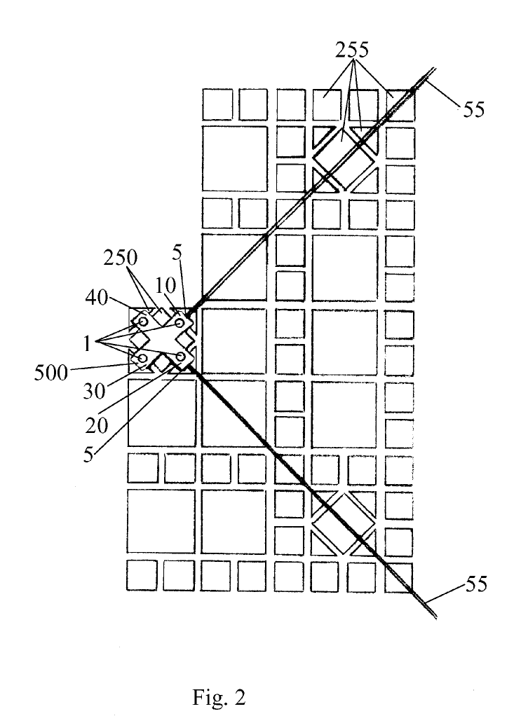

The cross level 500, as shown in FIG. 2, is used in laying and aligning decorative tiles 250. The cross level 500 may be used to level the tiles 250 on which it is in contact. The cross level 500 includes means for emitting a laser beam 5 to emit laser beams 55 to properly align the decorative tiles 250 with previously laid tiles 255. Thus, the cross level 500 may be used to simultaneously lay and align tiles 250. The laser beams 55 may be projected from the means for emitting a laser beam 5 of the each of the first distal end 11 of the first arm 10, the second distal end 21 of the second arm 20, the third distal end 31 of the third arm 30 and the fourth distal end 41 of the fourth arm 40 of the cross level 500 to allow the craftsman to check the alignment of the tiles 250 with previously laid tiles 255 or a reference point. The cross level 500 may be constructed so that the means for emitting a laser beam 5 emit laser beams 55 parallel to the first arm 10 and second arm 20, as shown in FIG. 2, or the laser beams 55 may be emitted at any angle from about 5 degrees to about 175 degrees depending upon the desired decorative pattern of the tiles 250.

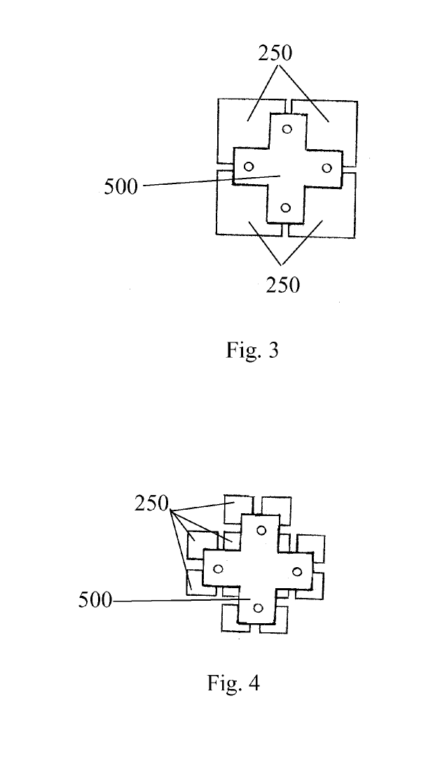

The cross level 500, as shown in FIG. 3, is used in laying four tiles 250 simultaneously.

The cross level 500, as shown in FIG. 4, is used in laying twelve tiles 250 simultaneously.

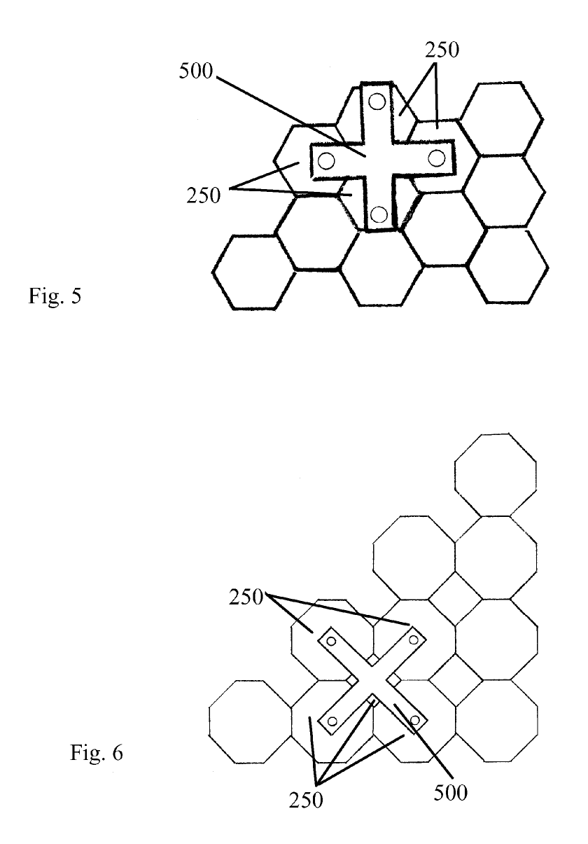

The cross level 500, as shown in FIG. 5, is used in laying four tiles 250 simultaneously.

The cross level 500, as shown in FIG. 6, is used in laying five tiles 250 simultaneously.

A single craftsman may use the present invention to simultaneously level and/or plumb more than two surfaces on the same or on a different plane in more than two different directions from a common nexus. For example, when a craftsman lays tiles on the floor or the wall, the craftsman must keep the construction straight, level and square. The present invention is especially beneficial to the craftsman who is laying tiles as the present invention allows the craftsman to use one tool to check the level, plumb and/or alignment of more than two tiles simultaneously.

What is claimed is:

1. A cross level comprising:
a base having a first arm, a second arm, a third arm and a fourth arm;
said first arm, said second arm, said third arm and said fourth arm extend along a common plane;
said first arm is perpendicular to said second arm and to said fourth arm;
said third arm is perpendicular to said second arm and to said fourth arm;
said third arm extends 1 80 degrees from said first arm; and,
said base comprising a plurality of level indicating means.

2. The cross level according to claim 1, wherein at least one of said plurality of level indicating means is located on said first arm.

3. The cross level according to claim 1, wherein at least one of said plurality of level indicating means is located on said second arm.

4. The cross level according to claim 1, wherein at least one of said plurality of level indicating means is located on said third arm.

5. The cross level according to claim 1, wherein at least one of said plurality of level indicating means is located on said fourth arm.

6. The cross level according to claim 1 further comprising: a temperature indicating means.

7. The cross level according to claim 6, wherein said base has a plurality of apertures.

8. The cross level according to claim 7, wherein at least one of said plurality of apertures is located on said first arm.

9. The cross level according to claim 7, wherein at least one of said plurality of apertures is located on said second arm.

10. The cross level according to claim 7, wherein at least one of said plurality of apertures is located on said third arm.

11. The cross level according to claim 7, wherein at least one of said plurality of apertures is located on said fourth arm.

12. A cross level comprising:
a base having a first arm, a second arm, a third arm and a fourth arm;
said first arm, said second arm, said third arm and said fourth arm extend along a common plane;
wherein said first arm has a first distal end, said first distal end having a means for a emitting a laser beam;
wherein said second arm has a second distal end, said second distal end having a means for a emitting a laser beam;
wherein said third arm has a third distal end, said third distal end having a means for a emitting a laser beam;
wherein said fourth arm has a fourth distal end, said fourth distal end having a means for a emitting a laser beam;
said first arm is perpendicular to said second arm and to said fourth arm;
said third arm is perpendicular to said second arm and to said fourth arm;
said third arm extends 1 80 degrees from said first arm; and,
said base comprising a plurality of level indicating means.

13. The cross level according to claim 12, wherein at least one of said plurality of level indicating means is located on said first arm.

14. The cross level according to claim 12, wherein at least one of said plurality of level indicating means is located on said second arm.

15. The cross level according to claim 12, wherein at least one of said plurality of level indicating means is located on said third arm.

16. The cross level according to claim 12, wherein at least one of said plurality of level indicating means is located on said fourth arm.

17. The cross level according to claim 12 further comprising: a temperature indicating means.

18. The cross level according to claim 17, wherein said base has a plurality of apertures.

19. The cross level according to claim 18, wherein at least one of said plurality of apertures is located on said first arm.

20. The cross level according to claim 18, wherein at least one of said plurality of apertures is located on said second arm.

21. The cross level according to claim 18, wherein at least one of said plurality of apertures is located on said third arm.

22. The cross level according to claim 18, wherein at least one of said plurality of apertures is located on said fourth arm.
